(19) United States
(12) Patent Application Publication
(10) Pub. No.: US 2019/0014269 A1
(43) Pub. Date: Jan. 10, 2019

(54) Device with Lens, Bezel, and Mechanical Upright, and Corresponding Systems and Methods

(71) Applicant: Motorola Mobility LLC, Chicago, IL (US)

(72) Inventors: Yuxin Wang, Palatine, IL (US); Alberto R. Cavallaro, Northbrook, IL (US); Roger Harmon, Crystal Lake, IL (US)

(21) Appl. No.: 15/642,182

(22) Filed: Jul. 5, 2017

(51) Int. Cl. H04N 5/247; H04N 5/225; G03B 17/02; G02B 13/00

(52) U.S. Cl. CPC H04N 5/247; H04N 5/2252; G02B 13/005; G03B 17/02; H04N 5/2253

(57) ABSTRACT

A device includes a housing defining a first major face having a first normal axis extending from the first major face in a first direction. A first convex lens protrudes from the first major face. A first bezel at least partially surrounds the first convex lens. At least one mechanical upright extends from the first bezel to a first height that is greater than a second height that the convex lens protrudes from the first major face.

### BACKGROUND

### Technical Field

This disclosure relates generally to devices, and more particularly to devices with lenses.

### Background Art

People use portable electronic devices, including smartphones, tablet computers, gaming devices, and other devices, every day. People use such devices to communicate with friends, family, and colleagues, manage calendars and contact lists, browse and explore the Internet, and play games. Most all modern portable electronic devices are even equipped with cameras for capturing still or video images.

While the science associated with the materials used for display fascia, lenses, and other optically transparent components of portable electronic devices has improved, these materials are not perfect. While many devices can withstand a drop from several feet to wood or concrete, there is still a risk that optically transparent components like a fascia for a display or a lens for an imager to become damaged. It would be advantageous to have an improved device that reduced the likelihood for such damage.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates another explanatory electronic device in accordance with one or more embodiments of the disclosure.

FIG. 3 illustrates a top plan view of one explanatory imaging device in accordance with one or more embodiments of the disclosure.

FIG. 4 illustrates a front elevation view of one explanatory imaging device in accordance with one or more embodiments of the disclosure.

FIG. 5 illustrates a right elevation view of one explanatory imaging device in accordance with one or more embodiments of the disclosure.

FIG. 6 illustrates a rear elevation view of one explanatory imaging device in accordance with one or more embodiments of the disclosure.

FIG. 7 illustrates a bottom plan view of one explanatory imaging device in accordance with one or more embodiments of the disclosure.

FIG. 8 illustrates a left elevation view of one explanatory electronic device in accordance with one or more embodiments of the disclosure.

FIG. 9 illustrates another left elevation view of one explanatory electronic device in accordance with one or more embodiments of the disclosure.

FIG. 10 illustrates explanatory fields of view for imagers in accordance with one or more embodiments of the disclosure.

FIG. 11 illustrates one explanatory obstructed portion of a field of view for one imager in accordance with one or more embodiments of the disclosure.

FIG. 12 illustrates other explanatory obstructed portions of one or more fields of view for imagers in accordance with one or more embodiments of the disclosure.

FIG. 13 illustrates explanatory fields of view for imagers in accordance with one or more embodiments of the disclosure.

FIG. 14 illustrates one explanatory method in accordance with one or more embodiments of the disclosure.

FIG. 15 illustrates one or more method steps in accordance with one or more embodiments of the disclosure.

FIG. 16 illustrates one or more method steps in accordance with one or more embodiments of the disclosure.

FIG. 17 illustrates a top plan view of one explanatory imaging device in accordance with one or more embodiments of the disclosure.

FIG. 18 illustrates a front elevation view of one explanatory imaging device in accordance with one or more embodiments of the disclosure.

FIG. 19 illustrates a right elevation view of one explanatory imaging device in accordance with one or more embodiments of the disclosure.

FIG. 20 illustrates a rear elevation view of one explanatory imaging device in accordance with one or more embodiments of the disclosure.

FIG. 21 illustrates a bottom plan view of one explanatory imaging device in accordance with one or more embodiments of the disclosure.

FIG. 22 illustrates another explanatory imaging device in accordance with one or more embodiments of the disclosure.

FIG. 23 illustrates yet another explanatory imaging device in accordance with one or more embodiments of the disclosure.

FIG. 24 illustrates still another explanatory imaging device in accordance with one or more embodiments of the disclosure.

FIG. 25 illustrates another explanatory imaging device in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that some embodiments reside primarily in combinations of method steps and apparatus components related to replacement of obstructed portions of a field of view from a first image with other portions of a second image. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that recent design trends corresponding to portable electronic devices have resulted in lenses for imagers protruding beyond the otherwise planar surface of the electronic device. Illustrating by example, many electronic devices today are configured as thin, rectangular devices. Consumers sometimes like for them to be as thin as possible. At the same time, consumers frequently desire high-resolution cameras with wide fields of view. Such cameras can require relatively thick—compared to the electronic device or the thin fascia spanning the display—lenses. Moreover, wide fields of view can require curved, convex lenses. These lenses may therefore overhang the sides of the housing.

When a convex, optically transparent object, like a lens, extends from a major face or other surface of an electronic device, there is an increased opportunity for the lens to be damaged if the electronic device is dropped or otherwise suffers impact. This is true because the protruding lens can be the first thing to hit the ground or other surface, with the weight of the electronic device being concentrated into the lens impact point. Even where the lens is manufactured from heat-treated, high strength glass, such impacts can be too much to bear, resulting in a cracked lens. Embodiments of the disclosure contemplate that there is a need to develop protection for features that protrude from an electronic device, especially where those features are optically transparent.

Embodiments of the present disclosure advantageously provide such protection, thereby extending the lifespan of lenses and other protruding objects. In one embodiments, a housing includes a major face. A convex object protrudes from the major face. One example of such a convex object is a lens for an image capture device. While this will be used as an example of a convex, protruding object for illustration, it should be noted that embodiments of the disclosure are not so limited. The protruding object could take other forms as well. For example, the protruding object could be a push button. Alternatively, the protruding object could be a biometric sensor. Accordingly, while a lens is used as an example of a protruding object, the mechanical protection used to protect the lens could be used with other protruding objects as well, as will be understood by those of ordinary skill in the art having the benefit of this disclosure.

In one embodiment, a convex lens protrudes from the major face of the device. A bezel, which could be integral with the housing of the device or a separate component, at least partially surrounds the convex lens. In one or more embodiments, at least one mechanical upright extends from the bezel to a height that is greater than the height of the convex lens. Accordingly, if the device is dropped, the taller mechanical upright will prevent the convex lens from serving as the impact point. If, for example, the device is dropped on a concrete surface with the convex lens oriented down, the mechanical upright will connect with the concrete surface before the convex lens, thereby dissipating energy into the bezel and housing of the device. This serves to protect the convex lens and prevent it from cracking.

Embodiments of the disclosure contemplate that the inclusion of one or more mechanical uprights can cause the field of view of the image capture device operating in conjunction with the convex lens to be obstructed. For example, in one or more embodiments the convex lens allows each imager to have a field of view that is greater than 180 degrees. Since the mechanical uprights are located adjacent to the convex lens in one or more embodiments, at least a portion of the field of view will be obstructed by the mechanical uprights.

To solve this issue, in one embodiment a device includes a first major face facing outward in a first direction, and a second major face facing outward in a second direction that is opposite the first direction. Each major face includes a convex lens and a corresponding imager. For example, in one embodiment a first convex lens extends from the first major face and is at least partially surrounded by a bezel, while a second convex lens extends from the second major face and is at least partially surrounded by a second bezel. As noted, the bezels can be integrated within the housing of the devices, or can be separate components coupled thereto.

In one embodiment, one or more mechanical uprights extend from the first bezel. Similarly, one or more mechanical uprights extend from the second bezel. A first imager, disposed within the device behind the first convex lens, has a first field of view that is greater than 180 degrees. A second imager, disposed within the device behind the second convex lens, also has a field of view that is greater than 180 degrees. As such, the fields of view of each imager overlap.

In one or more embodiments, one or more processors operable with each imager cause the first imager and the second imager to capture images. Portions of the image captured by the first imager may be obstructed by the mechanical uprights extending from the bezel disposed about the first convex lens. Similarly, portions of the image captured by the second imager may be obstructed by the mechanical uprights extending from the bezel disposed about the second convex lens.

In one or more embodiments, the mechanical uprights extending from the first bezel are out of phase with the mechanical uprights extending from the second bezel. Illustrating by example, where a first mechanical upright and a second mechanical upright extend from the first bezel, they may be oriented at the 12 o'clock and 6 o'clock positions relative to the first convex lens. Similarly, where a third mechanical upright and a fourth mechanical upright extend from the second bezel, they may oriented at the 3 o'clock and 9 o'clock positions relative to the second convex lens.

This “out of phase” orientation of the mechanical uprights, combined with the overlapping fields of view of the first imager and the second imager, allow portions from the first image and second image to be substituted into each other to compensate for the obstruction occurring due to the mechanical uprights. For instance, the one or more processors may replace portions of the second image obstructed by the third mechanical upright and the fourth mechanical upright with other portions taken from the first image that are unobstructed. Other advantages of embodiments of the disclosure will be obvious to those of ordinary skill in the art having the benefit of this disclosure.

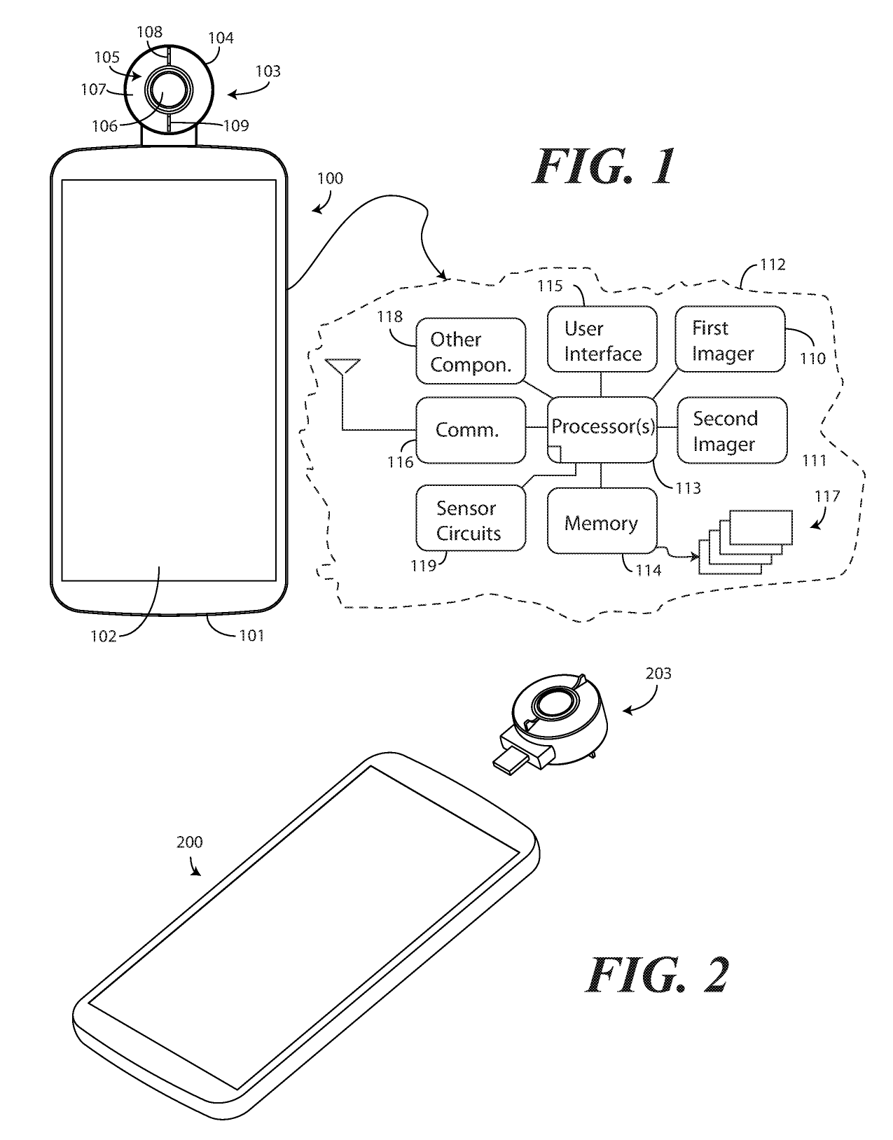

Turning now to FIG. 1, illustrated therein is one explanatory electronic device 100 in accordance with one or more embodiments of the disclosure. The electronic device 100 of FIG. 1 is shown as a portable electronic device. For ease of illustration, the electronic device 100 of FIG. 1 is shown illustratively as a smartphone. However, the electronic device 100 can take other forms as well, including as a palm top computer, a gaming device, a laptop computer, a multimedia player, and so forth. Still other examples of electronic devices will be obvious to those of ordinary skill in the art having the benefit of this disclosure.

In one or more embodiments, the electronic device 100 includes a housing 101. The housing 101 can include one or more housing portions, such as a first housing portion and a second housing portion. In this illustrative embodiment, the housing 101 is disposed about the periphery of a display 102, thereby defining a major face of the electronic device 100.

As will be described in more detail below, in one or more embodiments the electronic device 100 is selectively attachable and detachable from an attachment, which is configured as an auxiliary image capture device in one or more embodiments. The auxiliary image capture device can be a traditional digital camera. However, in one or more embodiments, the auxiliary image capture device is an attachment that includes a first major face facing outward from the attachment in a first direction and a second major face facing outward from the attachment in a second direction opposite the first direction. The first major face can comprise a first convex lens at least partially surrounded by a first bezel, while the second major face can comprise a second convex lens at least partially surrounded by a second bezel. A first mechanical upright can extend distally from the first major face farther than the first convex lens, while a second mechanical upright extends distally from the second major face farther than the second convex lens.

In the embodiment of FIG. 1, an image capture device 103 is integrally formed as an extension of the housing 101, extending from the top of the housing 101 in this illustrative embodiment. The image capture device 103 includes a housing 104 defining a first major face 105. The first major face 105 has a first normal axis extending from the first major face 105 in a first direction, which is out of the page as the electronic device 100 is viewed in FIG. 1.

In one or more embodiments, a convex lens 106 protrudes from the first major face 105. A bezel 107 at least partially surrounding the convex lens 106. In the illustrative embodiment of FIG. 1, the bezel 107 completely surrounds, i.e., circumscribes, the convex lens 106. In other embodiments, the bezel 107 only partially surrounds the convex lens 106. As noted above, the bezel 107 and housing 104 of the image capture device 103 can be integral such that they are portions of the same component in one or more embodiments. In other embodiments, the bezel 107 is a separate piece that is detachable from the housing 101 and couples to the housing 101 to retain the convex lens 106 at a desired location along the first major face 105.

In one or more embodiments, at least one mechanical upright extends from the bezel 107. In the illustrative embodiment of FIG. 1, a first mechanical upright 108 and a second mechanical upright 109 each extend distally from the bezel 107 outward from the page as viewed in FIG. 1. In one or more embodiments, the first mechanical upright 108 and the second mechanical upright 109 extend from the bezel 107 to a first height that is greater than a second height that the convex lens 106 protrudes from the first major face 105 of the image capture device 103. Illustrating by example, in one or more embodiments the first mechanical upright 108 and the second mechanical upright 109 extend about 0.2 millimeters higher from the first major face 105 than does the apex of the convex lens 106.

An imager 110, such as a digital image sensor, is disposed behind the convex lens 106 in one embodiment. The imager receives light through the convex lens 106 when capturing images. A second imager 111 can be disposed behind a second convex lens as will be described in more detail below. The second imager 111 and second convex lens can be located on the first major face 105 in one embodiment. In other embodiments, the second imager 111 and the second convex lens can be located on a second major face of the image capture device 103 facing opposite the first, i.e., into the page as viewed in FIG. 1.

A block diagram schematic 112 of the electronic device 100 is also shown in FIG. 1. In one embodiment, the electronic device 100 includes one or more processors 113. The one or more processors 113 are operable with the display 102 and other components of the electronic device 100. The one or more processors 113 can include a microprocessor, a group of processing components, one or more ASICs, programmable logic, or other type of processing device. The one or more processors 113 can be operable with the various components of the electronic device 100. The one or more processors 113 can be configured to process and execute executable software code to perform the various functions of the electronic device 100.

A storage device, such as memory 114, can optionally store the executable software code used by the one or more processors 113 during operation. The memory 114 may include either or both static and dynamic memory components, may be used for storing both embedded code and user data. The software code can embody program instructions and methods to operate the various functions of the electronic device 100, and also to execute software or firmware applications and modules. The one or more processors 113 can execute this software or firmware, and/or interact with modules, to provide device functionality.

In one or more embodiments the electronic device 100 includes a display 102, which may optionally be touch-sensitive. In one embodiment where the display 102 is touch-sensitive, the display 102 can serve as a primary user interface 115 of the electronic device 100. Users can deliver user input to the display 102 of such an embodiment by delivering touch input from a finger, stylus, or other objects disposed proximately with the display. In one embodiment, the display 102 is configured as an organic light emitting diode (OLED) display. However, it should be noted that other types of displays would be obvious to those of ordinary skill in the art having the benefit of this disclosure. In one embodiment, the display 102 includes an electroluminescent layer or light-emitting diode (LED) backlighting layer disposed beneath the display 102 to project light through the display 102. The display 102 can adaptively present text, graphics, images, user actuation targets, data, and controls along the display surface.

In this illustrative embodiment, the electronic device 100 also includes an optional communication circuit 116 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 116 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 116 can include wireless communication circuitry, one of a receiver, a transmitter, or transceiver, and one or more antennas.

The one or more processors 113 can be responsible for performing the primary functions of the electronic device 100. For example, in one embodiment the one or more processors 113 comprise one or more circuits operable with the first imager 110, the second imager 111 (where included), the one or more user interface devices and the other components of the electronic device 100. The executable software code used by the one or more processors 113 can be configured as one or more modules 117 that are operable with the one or more processors 113. Such modules 117 can store instructions, control algorithms, and so forth. While these modules 117 are shown as software stored in the memory 114, they can be hardware components or firmware components integrated into the one or more processors 113 as well.

One or more imagers can be included with the electronic device 100. As noted above, in this illustrative embodiment a first imager 110, and optionally a second imager 111, are included and are operable with the one or more processors. In other embodiments, only one imager will be included. In still other embodiments, more than two imagers will be included. Illustrating by example, where the image capture device 103 is a three-dimensional image capture device, it may include two, three, four, five, or more imagers. Other numbers of imagers will be obvious to those of ordinary skill in the art having the benefit of this disclosure.

The first imager 110 and the second imager 111 can be any type of image sensor known in the art, including complementary metal-oxide semiconductor (CMOS) or charge-coupled device (CCD) sensors. In one or more embodiments, the first imager 110 is configured to receive light through the convex lens 106. Where the second imager 111 is included, it can receive light through a second convex lens. The light may be reflected off a subject, and defines an image that the first imager 110 and/or second imager 111 can capture. The light may be redirected or reflected within the image capture device 103 after passing through the convex lens 106 as well. For instance, a mirror or other object may redirect the light as it passes from the convex lens 106 to first imager 110. Further, the light may pass through an aperture as well.

In one or more embodiments, the one or more processors 113 are coupled to the first imager 110 and/or the second imager 111. The one or more processors 113 can be configured to cause the first imager 110 and/or the second imager 111 to capture electronic image data. The one or more processors 113 can control the various functions of the image capture device 103 in one or more embodimemts by executing instructions in the form of software code, which may be stored in an associated memory 114. Further, each of the modules that will be described herein can be embodied in the form of executable software or firmware code.

An energy storage device (not shown) can serve as a principal energy delivery device for the electronic device 100. In one or more embodiments, the energy storage device comprises a rechargeable battery having one or more electrochemical cells. The electrochemical cells can be any of lithium-ion cells, lithium-polymer cells, nickel-metal-hydride cells, or other types of rechargeable cells.

Other components 118 can be included with the electronic device 100. The other components 118 can be operable with the one or more processors 113 and can include input and output components associated with a user interface 115, such as power inputs and outputs, audio inputs and outputs, and/or mechanical inputs and outputs. The other components 118 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

One or more sensor circuits 119 can be operable with the one or more processors 113 in one or more embodiments. The one or more sensor circuits 119 can also be configured to sense or determine physical parameters indicative of conditions in an environment about the electronic device 100. Illustrating by example, the physical sensors can include devices for determining information such as motion, bearing, location, acceleration, orientation, proximity to people and other objects, incident light amounts, and so forth. The one or more sensor circuits 119 can include various combinations of microphones, location detectors, motion sensors, physical parameter sensors, temperature sensors, barometers, proximity sensor components, proximity detector components, wellness sensors, touch sensors, cameras, audio capture devices, and so forth.

The one or more sensor circuits 119 can also include a touch pad sensor, a touch screen sensor, a capacitive touch sensor, and one or more switches. The one or more sensor circuits 119 can also include audio sensors and video sensors (such as a camera). The one or more sensor circuits 119 can also include motion detectors, such as one or more accelerometers or gyroscopes. The motion detectors can detect movement, and direction of movement, of the electronic device 100 by a user. The one or more sensor circuits 119 can also be used to detect gestures. For example, the other one or more sensor circuits 119 can include one or more proximity sensors that detect the gesture of a user waving a hand above the display 102. In yet another embodiment, the accelerometer can detect gesture input from a user lifting, shaking, or otherwise deliberately moving the electronic device 100. It should be clear to those of ordinary skill in the art having the benefit of this disclosure that additional sensors can be included as well. Moreover, other types of sensor circuits 119 will be obvious to those of ordinary skill in the art having the benefit of this disclosure.

It is to be understood that FIG. 1 is provided for illustrative purposes only and for illustrating components of one electronic device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

Turning now to FIG. 2, illustrated therein is an alternate electronic device 200. In this embodiment, the image capture device 203 is configured as an attachment that can be selectively coupled to, or selectively decoupled from, the electronic device 200. Accordingly, in this embodiment a user can attach the attachment to the electronic device 200 when desiring to capture images. However, when not taking pictures, the user can detatch the attachment from the electronic device 200 and stow it in a pocket or other safe place.

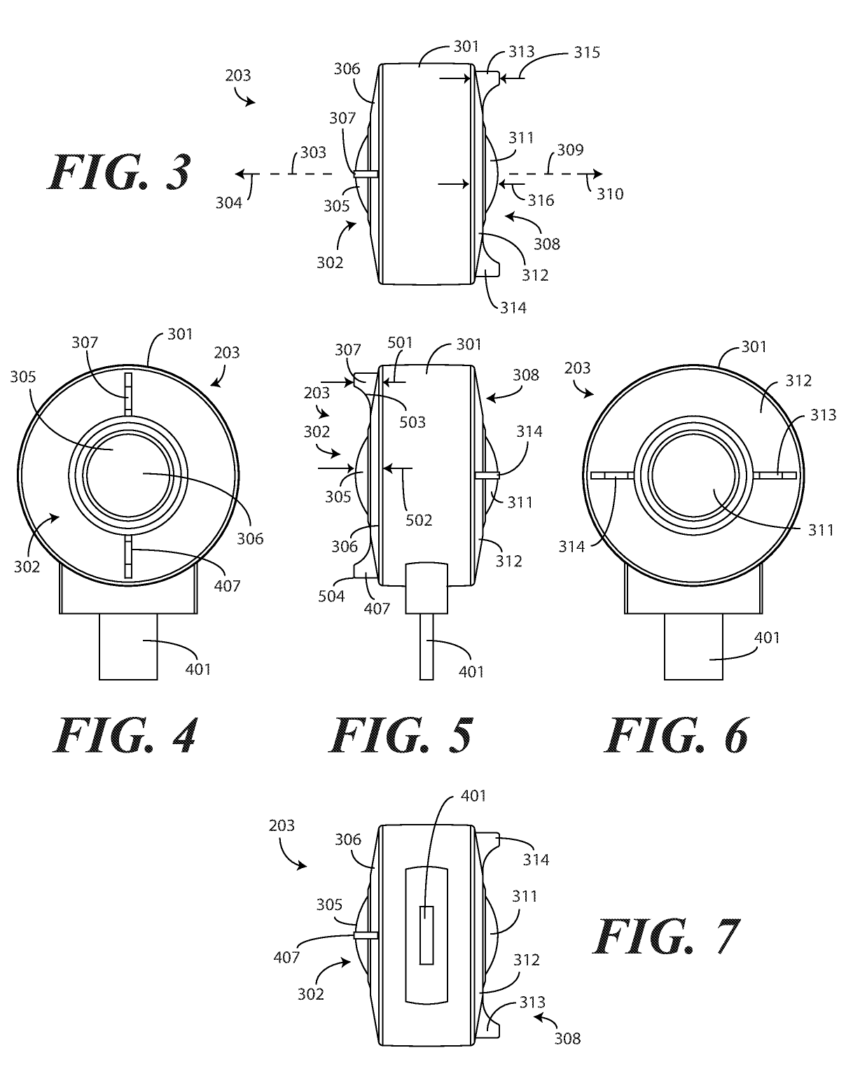

Turning now to FIGS. 3-7, illustrated therein is one embodiment of an image capture device 203 configured in accordance with one or more embodiments of the disclosure. For compact illustration, the image capture device 203 shown in FIGS. 3-7 is the attachment of FIG. 2. However, the mechanical details of the image capture device 203 can be the same for the image capture device (103) of FIG. 1 that was integrated with the housing (101) of that particular electronic device (100). Accordingly, the description of FIGS. 3-7 can apply equally to either the image capture device 203 or the image capture device (103) of FIG. 1.

As shown in FIGS. 3-7, the image capture device 203 includes a housing 301. The housing 301 can be manufactured from any of a number of materials, including metal, plastic, or other materials. A connector 401 can extend from the housing 301 to couple the image capture device 203 to an electronic device.

In one or more embodiments the housing 301 defines a first major face 302. In one or more embodiments, the first major face 302 has a normal axis 303, which is an imaginary reference line, extending from the first major face 302 in a first direction 304. Said differently, in this illustrative embodiment the first major face 302 “faces” outward from the housing 301 of the image capture device in the first direction 304.

In one or more embodiments, a convex object protrudes from the first major face 302. In this illustrative embodiment, a first convex lens 305 protrudes from the first major face 302. As noted above, an imager can be disposed within the housing 301 behind the first convex lens 305. The imager can receive light through the first convex lens 305 when capturing still or video images.

In one or more embodiments, a first bezel 306 at least partially surrounding the first convex lens 305. In the illustrative embodiment of FIGS. 3-7, the first bezel 306 completely surrounds, i.e., circumscribes, the first convex lens 305. In other embodiments, the first bezel 306 may only partially surrounds the first convex lens 305.

As noted above, in one embodiment the first bezel 306 is a defined by a first portion of the housing 301. For example, the first bezel 306 can simply be an extension of the housing 301 to the edge of the first convex lens 305. In other embodiments, the first bezel 306 can be a separate component that is attached to the housing 301. For example, the first bezel 306 may be plastic, while the housing 301 is metal in one embodiment. In another embodiment, the first bezel 306 and the housing 301 can both be metal, or plastic, or another material. The first bezel 306 may be colored differently than the housing 301 in one or more embodiments. Additionally, textures, printing, or other surface features can be applied to one or both of the housing 301 and the first bezel 306.

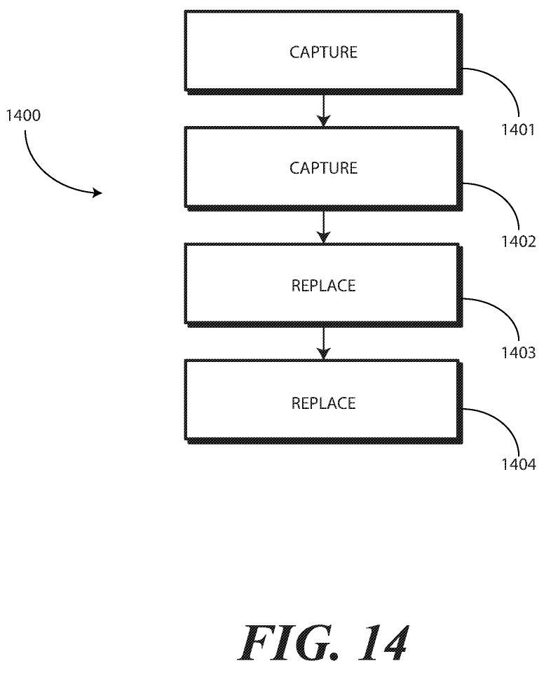

In one or more embodiments, at least one mechanical upright extends from the first bezel 306. In the illustrative embodiment, a first mechanical upright 307 and a second mechanical upright 407 each extend distally from the first bezel 306. While two mechanical uprights are shown extending from the first bezel 306 in FIGS. 3-7, in other embodiments only a single mechanical upright extends from the first bezel 306 as will be shown in FIGS. 14-18. In still other embodiments, three or more mechanical uprights can extend from the first bezel 306 as shown in FIG. 21. Other numbers of mechanical uprights will be obvious to those of ordinary skill in the art having the benefit of this disclosure.

The mechanical uprights can be integral to the first bezel 306 in one or more embodiments. In other embodiments, the mechanical uprights can be attached to the first bezel 306. For example, in one embodiment the first bezel 306, the first mechanical upright 307, and the second mechanical upright 407 are manufactured as a single part from plastic, metal, or another material. In another embodiment, the first mechanical upright 307 and the second mechanical upright 407 can be manufactured as separate components that are attached to the first bezel 306. The first mechanical upright 307 and the second mechanical upright 407 may be manufactured from plastic, for example, while the first bezel 306 is manufactured from metal, or vice versa. Even when the first mechanical upright 307 and the second mechanical upright 407 are separate components from the first bezel 306, they can be manufactured from the same material as the first bezel 306.

In one or more embodiments, the first mechanical upright 307 and the second mechanical upright 407 each extend to a first height 501. In one or more embodiments, the first height 501 is greater than a second height 502 that the convex lens 305 protrudes from the first major face 302. By extending away from the first major face 302 more than the first convex lens 305, the first mechanical upright 307 and the second mechanical upright 407 serve as protection devices for the first convex lens 305. If the image capture device 203 were dropped, with the first convex lens 305 oriented toward an impact surface, one or both of the first mechanical upright 307 and the second mechanical upright 407 would engage the impact surface before the apex of the first convex lens 305, thereby dissipating energy into the first bezel 306. This works to prevent the first convex lens 305 from being broken, cracked, scratched, or otherwise damaged.

In the illustrative embodiment of FIGS. 3-7, the first convex lens 305 is disposed between the first mechanical upright 307 and the second mechanical upright 407. In this illustrative embodiment, first mechanical upright 307 is rotated 180 degrees out of phase around the first convex lens 305 relative to the second mechanical upright 407. If the first major face 302, as viewed in the front elevation view of FIG. 4, were a clock, the first mechanical upright 307 and the second mechanical upright are at 12 o'clock and 6 o'clock positions relative to the first convex lens 305 in this illustrative embodiment.

The first mechanical upright 307 and the second mechanical upright 407 can take a variety of shapes. In one embodiment, each of the first mechanical upright 307 and the second mechanical upright 407 are rectangular in cross section. In another embodiment, each of the first mechanical upright 307 and the second mechanical upright 407 are domed. In another embodiment, each of the first mechanical upright 307 and the second mechanical upright 407 are triangular in cross section. Other shapes for the first mechanical upright 307 and the second mechanical upright 407 will be obvious to those of ordinary skill in the art having the benefit of this disclosure.

In the illustrative embodiment of FIGS. 3-7, as best shown in FIG. 4, the first mechanical upright 307 and the second mechanical upright 407 each define fins having a rectangular front cross section. In this illustrative embodiment, as best shown in FIG. 5, the side cross section of the first mechanical upright 307 and the second mechanical upright 407 defines a concave recess 503. In one embodiment, the concave recess 503 is oriented toward the first convex lens 305. In one embodiment, the side cross section of the first mechanical upright 307 and the second mechanical upright 407 also defines a convex surface 504. In this illustrative embodiment, the convex surface 504 is oriented away from the first convex lens 305. As noted, other shapes for the first mechanical upright 307 and the second mechanical upright 407 will be obvious to those of ordinary skill in the art having the benefit of this disclosure.

In one or more embodiments, the housing 301 can also define a second major face 308. In one embodiment, the second major face 308 has a second normal axis 309 extending from the second major face 308 in a second direction 310. In this illustrative embodiment, the second direction 310 is opposite, i.e., 180 degrees out of phase with, the first direction 304. Thus, as viewed in FIG. 3, the first direction 304 is due left, while the second direction 310 is due right. Said differently, the second major face 308 faces outward from the housing 301 in the second direction 310, which is opposite the first direction 304.

In one or more embodiments, the second major face 308 comprises a second convex lens 311. In one or more embodiments, the second convex lens 311 protrudes from the second major face 308 as best shown in FIGS. 3, 5, and 7.

In one embodiment, a second bezel 312 at least partially surrounding the second convex lens 311. As with the first bezel 306, the second bezel 312 can completely surround the second convex lens 311 in one embodiment. In other embodiments, the second bezel 312 may only partially surrounds the second convex lens 311.

As with the first bezel 306, in one or more embodiments at least one other mechanical upright extends from the second bezel 312. In this illustrative embodiment, a third mechanical upright 313 and a fourth mechanical upright 314 extend distally from the second bezel 312. As with the first bezel 306, the second bezel 312 may include only one mechanical upright, or three or more mechanical uprights.

In this illustrative embodiment, the third mechanical upright 313 and the fourth mechanical upright 314 each extend from the second bezel 312 to a third height 315. In one embodiment, the third height 315 is greater than a fourth height 316 that the second convex lens 311 protrudes from the second major face 308. Accordingly, by extending away from the second major face 308 more than the second convex lens 311, the third mechanical upright 313 and the fourth mechanical upright 314 serve as protection devices for the second convex lens 311. If the image capture device 203 were dropped, with the second convex lens 311 oriented toward an impact surface, one or both of the third mechanical upright 313 and the fourth mechanical upright 314 would engage the impact surface before the apex of the second convex lens 311, thereby dissipating energy into the second bezel 312. This works to prevent the second convex lens 311 from being broken, cracked, scratched, or otherwise damaged.

In this illustrative embodiment, the second convex lens 311 is disposed between the third mechanical upright 313 and the fourth mechanical upright 314. In this illustrative embodiment, the third mechanical upright 313 and the fourth mechanical upright 314 have the same shape as the first mechanical upright 307 and the second mechanical upright 407. However, in other embodiments, the third mechanical upright 313 and the fourth mechanical upright 314 can have different shapes from each other or from the first mechanical upright 307 and the second mechanical upright 407. It should be noted that the first mechanical upright 307 and the second mechanical upright 407 can have shapes different from each other as well. Other configurations for shapes for the first mechanical upright 307, the second mechanical upright 407, the third mechanical upright 313, and the fourth mechanical upright 314 will be obvious to those of ordinary skill in the art having the benefit of this disclosure.

In this illustrative embodiment, the third mechanical upright 313 and the fourth mechanical upright 314 are “out of phase” with the first mechanical upright 307 and the second mechanical upright 407. The reason for this is that images taken by the first imager disposed behind the first convex lens 305 and the second imager disposed behind the second convex lens 311 can be “stitched” together to compensate for obstruction in the field of view caused by any of the first mechanical upright 307, the second mechanical upright 407, the third mechanical upright 313, or the fourth mechanical upright 314. How this occurs will be described in more detail below with reference to FIGS. 14-16.

The third mechanical upright 313 and the fourth mechanical upright 314 are angularly displaced relative to, or “out of phase” with, the first mechanical upright 307 and the second mechanical upright 407 due to the fact that they are disposed on the second bezel 312 at locations that are different from the locations that the first mechanical upright 307 and the second mechanical upright 407 are disposed on the first bezel 306. For example, the first mechanical upright 307 and the second mechanical upright are at 12 o'clock and 6 o'clock positions relative to the first convex lens 305 on the first bezel 306 in this illustrative embodiment, the third mechanical upright 313 and the fourth mechanical upright 314 are at 3 o'clock and 9 o'clock positions relative to the second convex lens 311 on the second bezel 312. This results in the third mechanical upright 313 and the fourth mechanical upright 314 being 90 degrees “out of phase” with the first mechanical upright 307 and the second mechanical upright 407. Other amounts of phase shift between the third mechanical upright 313 and the fourth mechanical upright 314 relative to the first mechanical upright 307 and the second mechanical upright 407 will be obvious to those of ordinary skill in the art having the benefit of this disclosure.

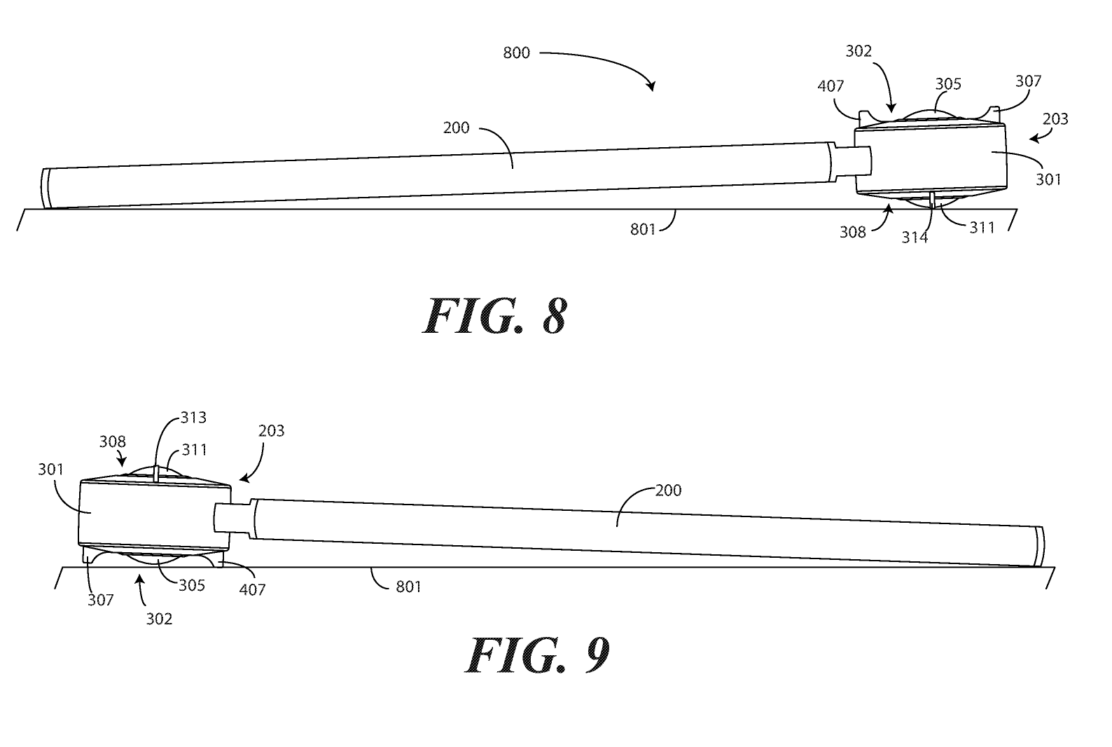

Turning now to FIGS. 8 and 9, illustrated therein are the protective characteristics of the first mechanical upright 307, the second mechanical upright 407, third mechanical upright 313, and the fourth mechanical upright 314. Beginning with FIG. 8, the image capture device 203 has been coupled to an electronic device 200. The attachment therefore extends distally from an edge of the housing of the electronic device 200.

As shown in FIG. 8, the assembly 800 has then been placed on its side on a flat surface 801. Since the third mechanical upright 313 and the fourth mechanical upright 314 extend farther from the second major face 308 than the second convex lens 311, the second convex lens 311 is prevented from touching the flat surface 801.

The same is true in FIG. 9. Since the first mechanical upright 307 and the second mechanical upright 407 extend farther from the first major face 302 than the first convex lens 305, the first convex lens 305 is prevented from touching the flat surface 801.

As noted above, in one or more embodiments a first imager (110) can disposed within the housing 301 of the image capture device 203 behind the first convex lens 305. Similarly, a second imager (111) can be disposed within the housing 301 behind the second convex lens 311. One advantage of using convex lenses is that they can provide the first imager (110) and the second imager (111) with a field of view that is greater than 180 degrees. Accordingly, two imagers, when mounted on oppositely facing major faces of the image capture device 203 can capture three-dimensional images in one or more embodiments.

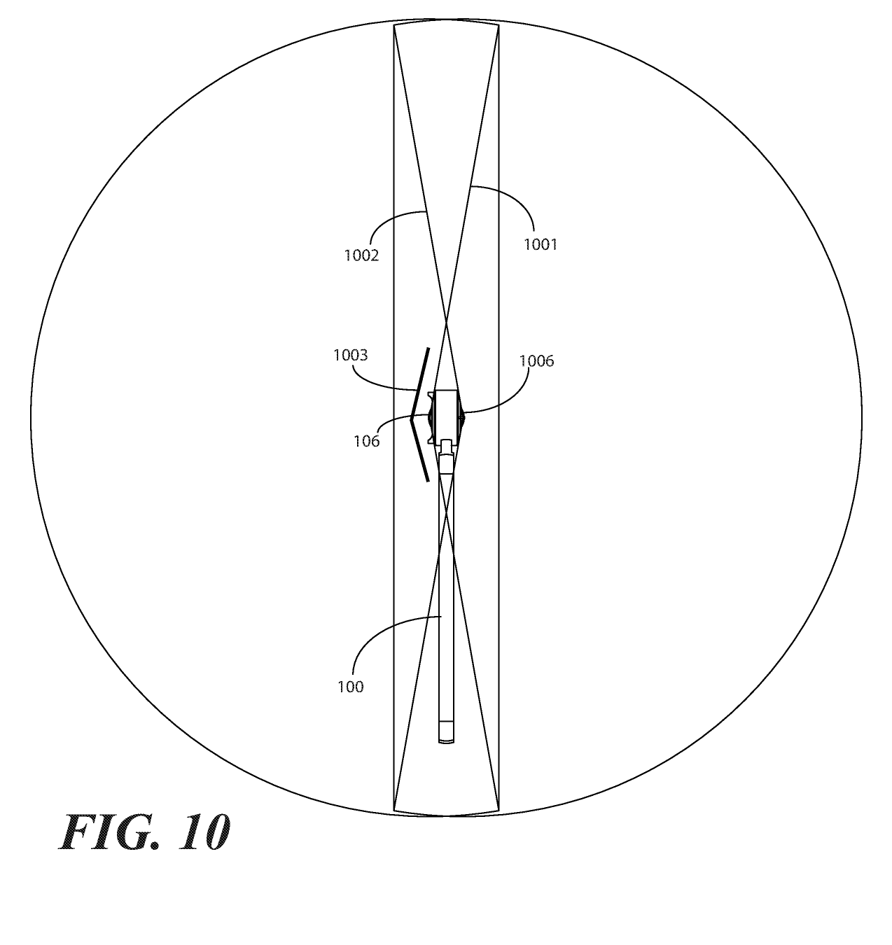

Turning now to FIG. 10, illustrated therein is the electronic device 100 of FIG. 1. As noted above, one or more processors (113) are operable with the first imager (110) and the second imager (111), each of which is disposed behind a first convex lens 106 and a second convex lens 1006, respectively.

As shown in FIG. 10, the first convex lens 106 defines a first field of view 1001 for the first imager (110). Similarly, the second convex lens 1006 defines a second field of view 1002 for the second imager (111). In this illustrative embodiment, each of the first field of view 1001 and the second field of view 1002 span an angle 1003 of more than 180 degrees. Illustrating by example, if the first convex lens 106 and the second convex lens 1006 are “fisheye” lenses, the angle 1003 can be as much as 240 degrees. This causes the first field of view 1001 and the second field of view 1002 to overlap 1004.

This overlap 1004 can be used to take portions of images captured by the second imager (111) and place them into images captured by the first imager (110) to compensate for obstructions caused by the one or more mechanical uprights extending from the first bezel. The opposite can occur as well—overlap 1004 can be used to take portions of images captured by the first imager (110) and place them into images captured by the second imager (111) to compensate for obstructions caused by the one or more mechanical uprights extending from the second bezel. For example, where the first convex lens 106 and the second convex lens 1006 are “fisheye” lenses, images captured by the first imager (110) and the second imager (111) can be combined to create a 360-degree “panoramic” image, with portions from the first image obstructed by mechanical uprights filled in with portions of the second image, and vice versa. This will be explained with reference to the figures that follow.

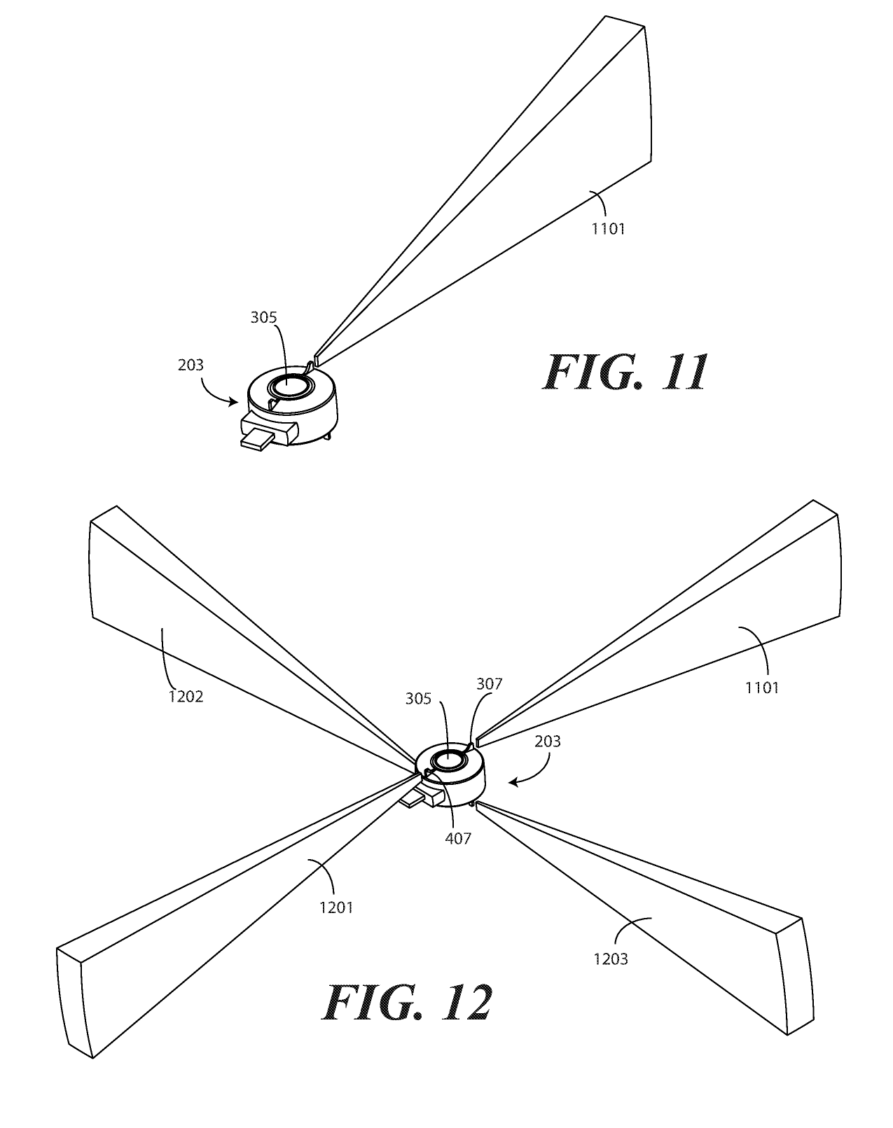

Turning now to FIG. 11, illustrated therein is the image capture device 203, shown here as an attachment. Also shown in FIG. 11 is a portion 1101 of the field of view of the first imager, disposed behind the first convex lens 305, that is obstructed when the first imager captures images. Expanding this concept, FIG. 12 shows that two portions 1101,1201 of the field of view of the first imager, disposed behind the first convex lens 305, will be obstructed when the first imager captures images. Similarly, two portions 1202,1203 of the field of view of the second imager, disposed behind the second convex lens (311), will be obstructed when the second imager captures images.

However, since the third mechanical upright (313) and the fourth mechanical upright (314) are “out of phase” with the first mechanical upright 307 and the second mechanical upright 407, the portions 1101,1201 of the field of view of the first imager obstructed by the first mechanical upright 307 and the second mechanical upright 407 are correspondingly “out of phase” with the portions 1202,1203 of the field of view of the second imager obstructed by the third mechanical upright (313) and the fourth mechanical upright (314).

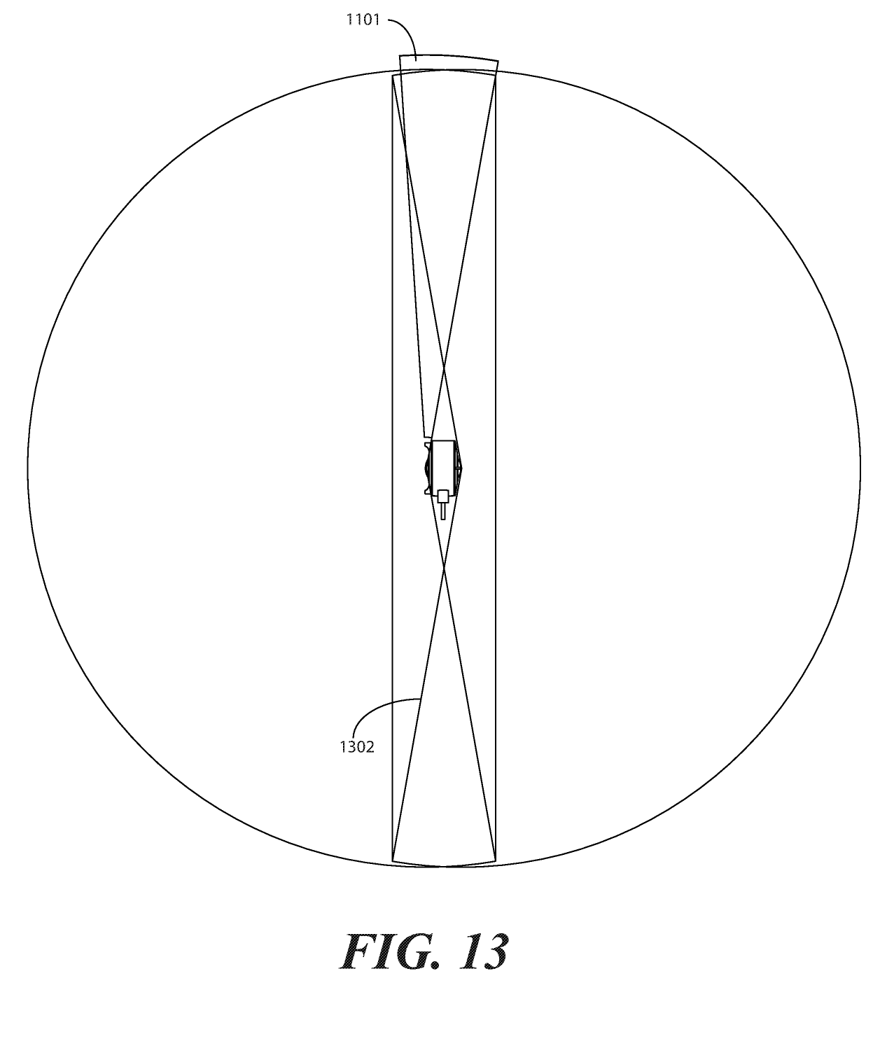

As shown in FIG. 13, this means that portion 1101 is obstructed from view from the first imager. However, due to the field of view 1302 of the second imager being greater than 180 degrees, and the fact that the third mechanical upright and the fourth mechanical upright are “out of phase” with the first mechanical upright and the second mechanical upright, portion 1101 is visible to the second imager. Accordingly, portion 1101 can be taken from images captured by the second imager and inserted into images captured by the first imager to compensate for the obstruction caused by the first mechanical upright. One illustrative method for doing this is shown in FIG. 14.

Turning now to FIG. 14, illustrated therein is one explanatory method 1400 in accordance with one or more embodiments of the disclosure. At step 1401, the method 1400 includes capturing a first image with a first imager through a first convex lens protruding from a first major face of a device. In one or more embodiments, the first convex lens gives the first imager a field of view that is greater than 180 degrees.

In one or more embodiments, at least one mechanical upright extends distally from the first major face farther than the first convex lens, such as a distance of about 0.2 millimeters beyond the first convex lens at step 1401. Due to the fact that the at least one mechanical upright is disposed adjacent to the convex lens, when the first image is captured at step 1401 one or more portions of the first image are obstructed by the at least one mechanical upright.

At step 1402, the method 1400 includes capturing a second image with a second imager. In one or more embodiments, the second image is captured through a second convex lens protruding from a second major face of the device. In one or more embodiments, the second convex lens gives the second imager a field of view that is greater than 180 degrees, causing its field of view to overlap that of the first imager. In one or more embodiments, at least one other mechanical upright extends distally from the second major face farther than the second convex lens.

In one or more embodiments, the at least one other mechanical upright disposed adjacent to the second convex lens is angularly displaced, or out of phase with, the at least one mechanical upright disposed adjacent to the first convex lens. Accordingly, where the field of view of the first imager and the second imager overlap, the second imager will capture information that is obstructed from view from the first imager by the at least one mechanical upright.

In one or more embodiments, these portions can be taken from the second image and placed into the first image to correct for the obstruction. The opposite can occur as well, i.e., portions of the first image can be taken from the first image and placed into the second image to compensate for obstruction by the at least one other mechanical upright. Specifically, at step 1403 the method 1400 includes replacing, with one or more processors operable with the first imager and the second imager, the one or more portions of the first image with one or more other portions of the second image. At step 1404, the method 1400 further includes replacing, with the one or more processors, a portion of the second image obstructed by the at least one other mechanical upright with another portion of the first image.

If the one or more mechanical uprights of step 1401 are disposed at the 3 o'clock and 9 o'clock positions about the first convex lens, the portions replaced at step 1403 will be at the 3 o'clock and 9 o'clock positions of the first image. Similarly, if the one or more mechanical uprights of step 1401 are arranged at the 12 o'clock and 6 o'clock positions about the first convex lens, the portions replaced at step 1403 will be at least at the 12 o'clock position, and optionally the 6 o'clock position, of the first image. The same would be true for the second image where the one or more other mechanical uprights are so arranged around the second convex lens.

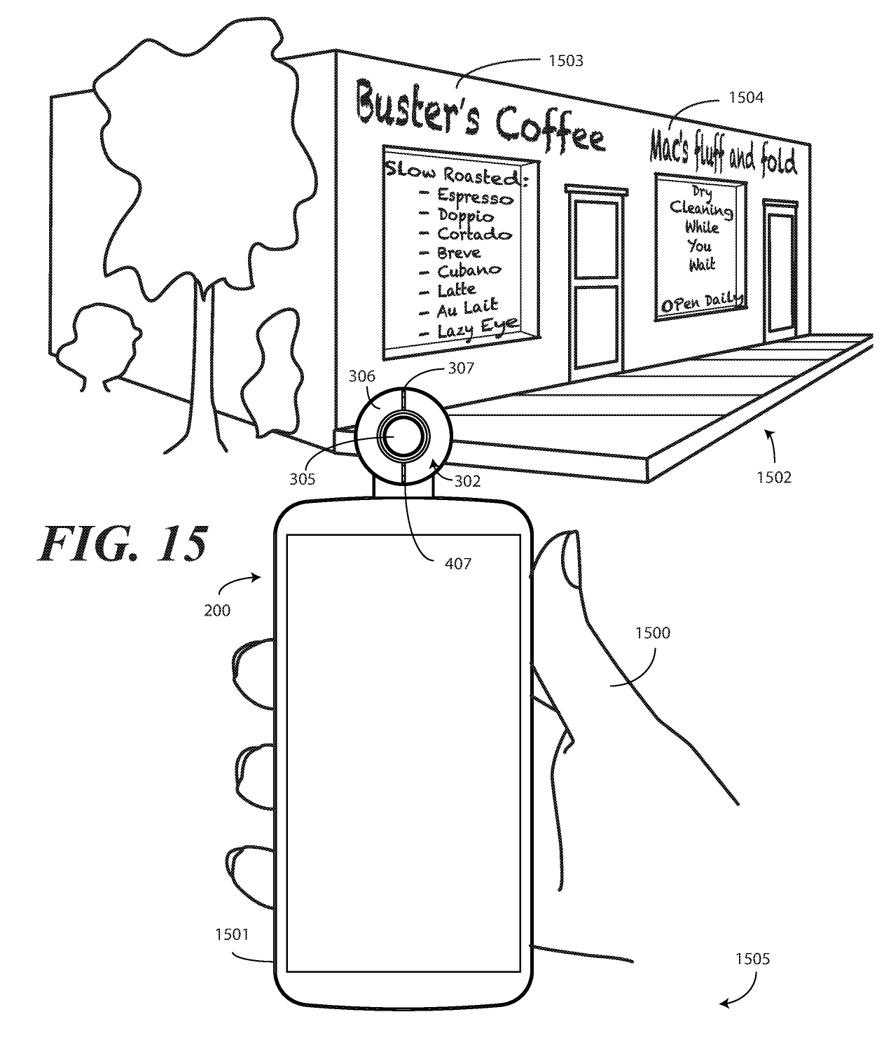

Turning now to FIGS. 15-25, the method (1400) of FIG. 14 is shown in action. Beginning with FIG. 15, a user 1500 is capturing an image with an electronic device 200. The electronic device 200 includes a housing 1501. An attachment, configured as an image capture device 203, extends distally from an edge of the housing 1501.

As previously described, the attachment includes a first major face 302 facing outward from the attachment in a first direction (out of the page) and a second major face (308) facing outward from the attachment in a second direction opposite the first direction (into the page). The first major face 302 comprises a first convex lens 305 at least partially surrounded by a first bezel 306. The second major face (308) comprises a second convex lens (311) at least partially surrounded by a second bezel (312).

A first mechanical upright 307 and a second mechanical upright 407 extend distally from the first major face 302 farther than the first convex lens 305 to protect the first convex lens 305 in the event that the electronic device 200 is dropped. A third mechanical upright (313) and a fourth mechanical upright (314) extend distally from the second major face (308) farther than the second convex lens (311) to protect the second convex lens (311) in the event that the electronic device 200 is dropped.

In this illustrative embodiment, the first mechanical upright 307 and the second mechanical upright 407 are at 12 o'clock and 6 o'clock positions relative to the first convex lens 305. The third mechanical upright (313) and the fourth mechanical upright (314) are at 3 o'clock and 9 o'clock positions relative to the second convex lens (311).

A first imager is disposed within the attachment behind the first convex lens 305. A second imager is disposed within the attachment behind the second convex lens (311). One or more processors operable with the first imager and the second imager. The first convex lens 305 defines a first field of view for the first imager, while the second convex lens (311) defines a second field of view for the second imager. In this illustrative embodiment, each of the first field of view and the second field of view span more than 180 degrees.

In the background 1502, which the second imager sees through the second convex lens (311), are the infamous Buster's Coffee House 1503 and Mac's Fluff and Fold 1504. In the foreground 1505, is a car (not shown in FIG. 24).

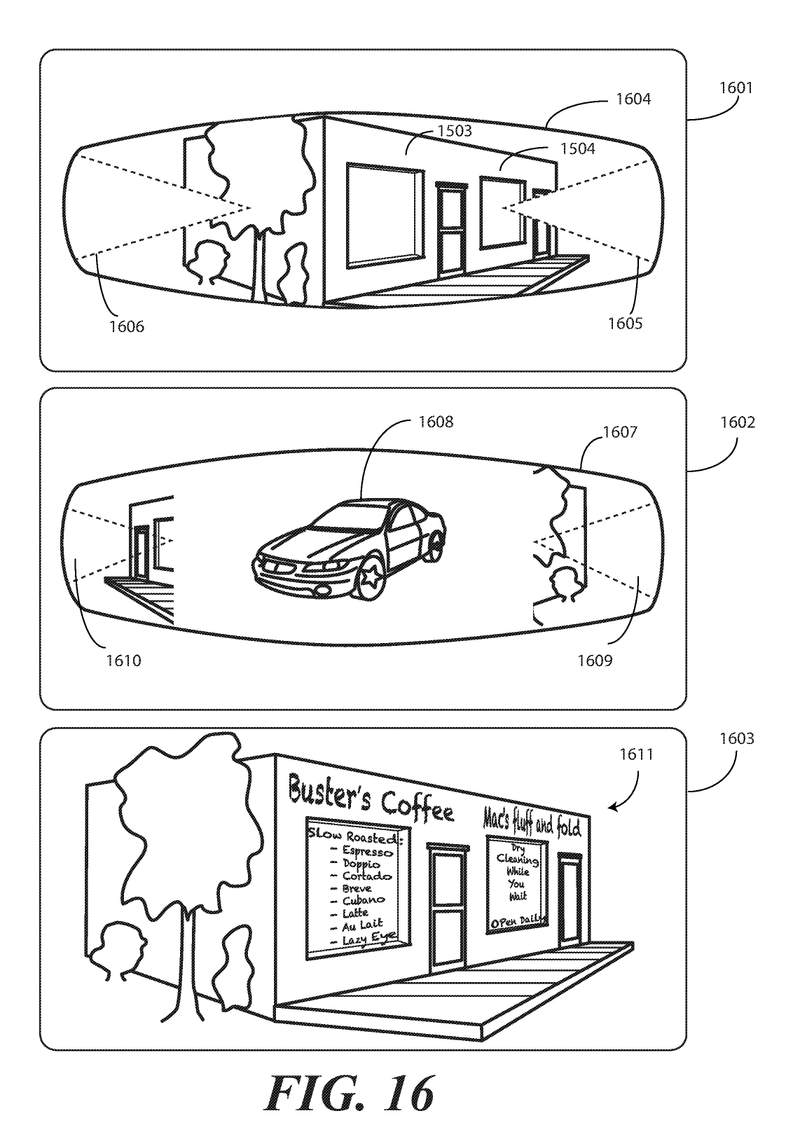

Turning now to FIG. 16, at step 1601, a first image 1604 is captured by the second imager through the second convex lens (311). While Buster's Coffee House 1503 and Mac's Fluff and Fold 1504 can be seen, a first portion 1605 and a second portion 1606 of the image 1604 are obstructed by the third mechanical upright (313) and the fourth mechanical upright (314), respectively.

However, at step 1602, a second image 1607 is captured by the first imager through the first convex lens (305). The car 1608, present in the foreground (1505) of the electronic device (200) can be seen. Since the field of view of the second imager overlaps that of the first imager, and since the first mechanical upright (307) and the second mechanical upright (407) are angularly displaced relative to, or offset from, the third mechanical upright (313) and the fourth mechanical upright (314), the portions 1605,1606 missing from the first image 1604 are captured as portions 1609,1610 of the second image 1607.

Thus, to compensate for the obstructed portions 1605,1606 of the first image 1604, in one or more embodiments the one or more processors, at step 1603, replace the portions 1605,1606 of the first image 1604 obstructed by the first mechanical upright (307) and the second mechanical upright (407) with other portions 1609,1610 taken from the second image 1607. A compensated image 1611 is shown at step 1603.

It should be noted that the same procedure can be applied to the second image 1607. The one or more processors can replace portions of the second image 1607 obstructed by the third mechanical upright (313) and the fourth mechanical upright (314) with other portions taken from the first image 1604. Where the first convex lens (305) and the second convex lens (311) are fisheye lenses so that the image capture device (203) can capture a 360-degree image of the environment of the electronic device (200), the images can be synthesized to create the 360-degree image.

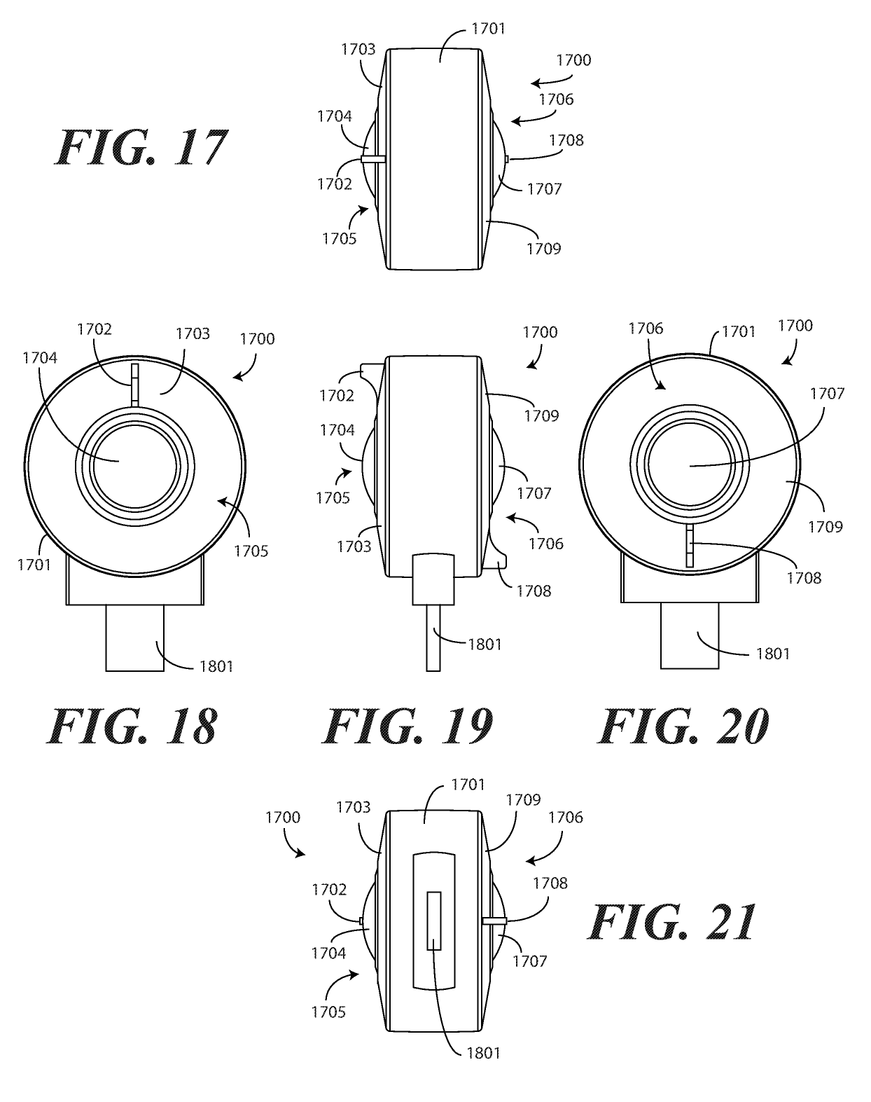

To this point, examples have included two mechanical uprights extending from each major face, with two mechanical uprights extending from a first major face being angularly displaced relative to two other mechanical uprights extending from a second major face by ninety degrees. However, embodiments of the disclosure are not so limited. Image capture devices can be configured in a variety of different ways. FIGS. 17-25 show a few ways this can occur. Still others will be obvious to those of ordinary skill in the art having the benefit of this disclosure.

Beginning with FIGS. 17-21, illustrated therein is another embodiment of an image capture device 1700 configured in accordance with one or more embodiments of the disclosure. The image capture device 1700 includes a housing 1701. The housing 1701 can be manufactured from any of a number of materials, including metal, plastic, or other materials. A connector 1801 can extend from the housing 1701 to couple the image capture device 1700 to an electronic device.

In this embodiment, rather than two mechanical uprights, a single mechanical upright 1702 extends from the first bezel 1703. The single mechanical upright 1702 is disposed at the 12 o'clock position relative to the first major face 1705. As before, the single mechanical upright 1702 extends to a height that is greater than another height that the first convex lens 1704 protrudes from the first major face 1705, thereby serving as protection for the first convex lens 1704. This works to prevent the first convex lens 1704 from being broken, cracked, scratched, or otherwise damaged.

As before, the housing 1701 also defines a second major face 1706. The second major face 1706 comprises a second convex lens 1707. Another single mechanical upright 1708 extends from the second bezel 1709. The other single mechanical upright 1708 extends to a third height that is greater than a fourth height that the second convex lens 1707 protrudes from the second major face 1706. This works to prevent the second convex lens 1707 from being broken, cracked, scratched, or otherwise damaged.

In this illustrative embodiment, the single mechanical upright 1702 on the front of the device 1700 and the other single mechanical upright 1708 on the second side of the device 1700 are “out of phase” with the first mechanical upright 307 and the second mechanical upright 407 by 180 degrees to allow for images taken by the first imager disposed behind the first convex lens 1704 and the second imager disposed behind the second convex lens 1707 to be “stitched” together to compensate for obstruction in the field of view caused by either the single mechanical upright 1702 on the front of the device 1700 and the other single mechanical upright 1708 on the second side of the device 1700 as previously described.

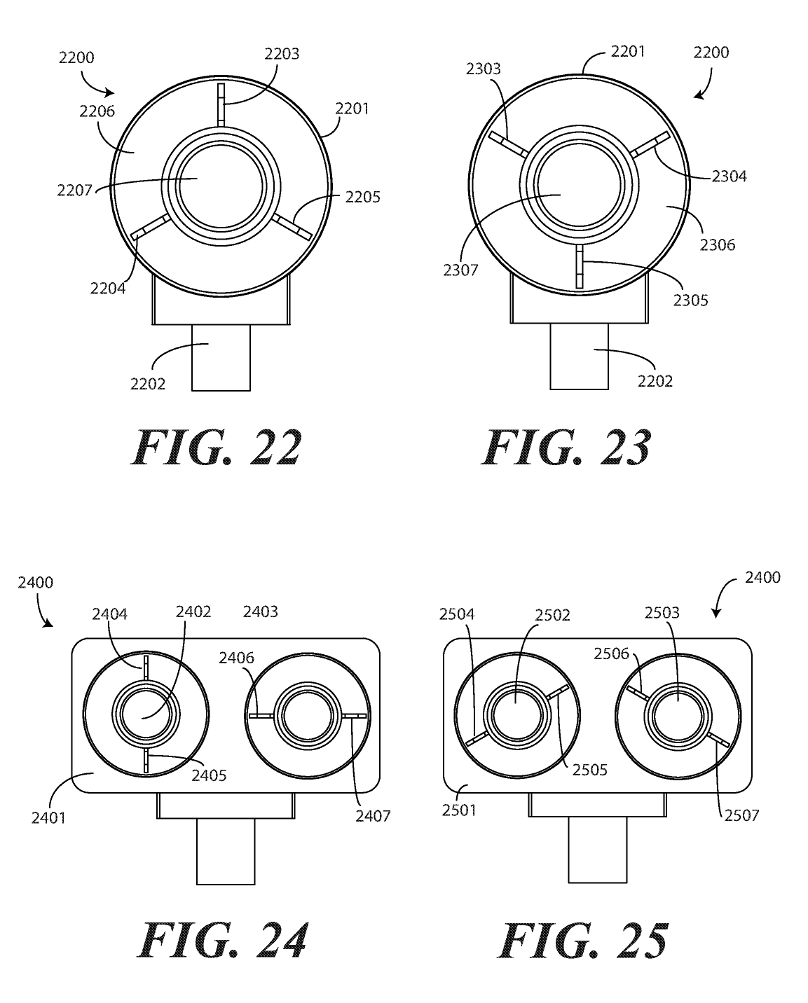

Turning now to FIGS. 22-23, illustrated therein is another embodiment of an image capture device 2200 configured in accordance with one or more embodiments of the disclosure. The image capture device 2200 includes a housing 2201. The housing 2201 can be manufactured from any of a number of materials, including metal, plastic, or other materials. A connector 2202 can extend from the housing 2201 to couple the image capture device 2200 to an electronic device.

In this embodiment, rather than two mechanical uprights, three mechanical uprights 2203,2204,2205 extend from the first bezel 2206, while three other mechanical uprights 2303,2304,2305 extend from the second bezel 2306. The three mechanical uprights 2203,2204,2205 are separated about the first convex lens 2207 by 120 degrees, with one mechanical upright 2203 in the 12 o'clock position. The three other mechanical uprights 2303,2304,2305 are separated about the second convex lens 2307 by 120 degrees, with one mechanical upright 2305 in the 6 o'clock position. Each mechanical upright 2203,2204,2205,2303,2304,2305 extends to a height greater than the corresponding convex lens 2207,2307 adjacent to which it is disposed. This offers protection to the corresponding convex lens 2207,2307, preventing them from being broken, cracked, scratched, or otherwise damaged.

Turning now to FIGS. 24-25, illustrated therein is another embodiment of an image capture device 2400 configured in accordance with one or more embodiments of the disclosure. Rather than having a single convex lens on each major face, here the first major face 2401 includes a first convex lens 2402 and a second convex lens 2403, while the second major face 2501 has a first convex lens 2502 and a second convex lens 2503. Each convex lens 2402,2403,2502,2503 has corresponding mechanical uprights 2404,2405,2406,2407,2504,2505, 2506,2507 disposed adjacent thereto, with those mechanical uprights 2404,2405,2406,2407, 2504,2505,2506,2507 rotated out of phase with others on the same major face and out of phase with those on the other major face. This provides protection as previously described, but also allows for images captured by the imagers disposed behind the convex lenses 2402,2403,2502,2503 to be corrected with portions from other images as previously described.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising:
a housing defining a first major face having a first normal axis extending from the first major face in a first direction;
a first convex lens protruding from the first major face;
a first bezel at least partially surrounding the first convex lens; and
at least one mechanical upright extending from the first bezel to a first height that is greater than a second height that the convex lens protrudes from the first major face.

2. The device of claim 1, wherein the at least one mechanical upright comprises a first mechanical upright and a second mechanical upright, wherein the first convex lens is disposed between the first mechanical upright and the second mechanical upright.

3. The device of claim 2, wherein the first mechanical upright is rotated 180 degrees out of phase around the first convex lens relative to the second mechanical upright.

4. The device of claim 3, wherein each mechanical upright defines a fin having a concave recess oriented toward the first convex lens and a convex surface oriented away from the first convex lens.

5. The device of claim 1, the housing further defining a second major face having a second normal axis extending from the second major face in a second direction, further comprising:
a second convex lens protruding from the second major face;
a second bezel at least partially surrounding the second convex lens; and
at least one other mechanical upright extending from the second bezel to a third height that is greater than a fourth height that the a second convex lens protrudes from the second major face.

6. The device of claim 5, wherein the first direction is opposite the second direction.

7. The device of claim 5, wherein:
the at least one mechanical upright comprises a first mechanical upright and a second mechanical upright;
the at least one other mechanical upright comprises a third mechanical upright and a fourth mechanical upright.

8. The device of claim 7, wherein:
the first convex lens is disposed between the first mechanical upright and the second mechanical upright; and
the second convex lens is disposed between the third mechanical upright and the fourth mechanical upright.

9. The device of claim 8, wherein:
the first mechanical upright and the second mechanical upright are at 12 o'clock and 6 o'clock positions relative to the first convex lens; and
the third mechanical upright and the fourth mechanical upright are at 3 o'clock and 9 o'clock positions relative to the second convex lens.

10. A device, comprising:
a housing; and
an attachment, extending distally from an edge of the housing, the attachment comprising:
a first major face facing outward from the attachment in a first direction; and
a second major face facing outward from the attachment in a second direction opposite the first direction;
the first major face comprising a first convex lens at least partially surrounded by a first bezel;
the second major face comprising a second convex lens at least partially surrounded by a second bezel;
a first mechanical upright extending distally from the first major face farther than the first convex lens; and
a second mechanical upright extending distally from the second major face farther than the second convex lens.

11. The device of claim 10, further comprising:
a third mechanical upright extending distally from the first major face farther than the first convex lens; and
a fourth mechanical upright extending distally from the second major face farther than the second convex lens.

12. The device of claim 11, wherein:
the first mechanical upright and the third mechanical upright are at 12 o'clock and 6 o'clock positions relative to the first convex lens; and
the second mechanical upright and the fourth mechanical upright at 3 o'clock and 9 o'clock positions relative to the second convex lens.

13. The device of claim 11, further comprising:
a first imager disposed within the attachment behind the first convex lens;
a second imager disposed within the attachment behind the second convex lens; and
one or more processors operable with the first imager and the second imager;
wherein:
the first convex lens defines a first field of view for the first imager; and
the second convex lens defines a second field of view for the second imager;
each of the first field of view and the second field of view spanning more than 180 degrees.

14. The device of claim 13, the one or more processors causing the first imager and the second imager to capture a first image and a second image, respectively, and replacing a portion of the first image obstructed by the first mechanical upright with another portion taken from the second image.

15. The device of claim 13, the one or more processors causing the first imager and the second imager to capture a first image and a second image, respectively, and replacing portions of the second image obstructed by the second mechanical upright and the fourth mechanical upright with other portions taken from the first image.

16. A method, comprising:
capturing a first image with a first imager through a first convex lens protruding from a first major face of a device with at least one mechanical upright extending distally from the first major face farther than the first convex lens, wherein one or more portions of the first image are obstructed by the at least one mechanical upright;
capturing a second image with a second imager through a second convex lens protruding from a second major face of the device with at least one other mechanical upright extending distally from the second major face farther than the second convex lens; and
replacing, with one or more processors operable with the first imager and the second imager, the one or more portions of the first image with one or more other portions of the second image.

17. The method of claim 16, wherein the first image and the second image each have a field of view greater than 180 degrees.

18. The method of claim 17, wherein the one or more portions are at 3 o'clock and 9 o'clock positions of the first image.

19. The method of claim 18, wherein the one or more portions are at least at a 12 o'clock position of the first image.

20. The method of claim 16, further comprising replacing, with the one or more processors, a portion of the second image obstructed by the at least one other mechanical upright with another portion of the first image.
